(19) United States
(12) Patent Application Publication
(10) Pub. No.: US 2019/0247262 A1
(43) Pub. Date: Aug. 15, 2019

(54) Waterproof Massage Apparatus

(71) Applicant: Cleveland E. Wheat, Reston, VA (US)

(72) Inventor: Cleveland E. Wheat, Reston, VA (US)

(21) Appl. No.: 16/257,430

(22) Filed: Jan. 25, 2019

Related U.S. Application Data
(60) Provisional application No. 62/710,078, filed on Feb. 9, 2018.

(51) Int. Cl. A61H 1/00; A61H 23/02

(52) U.S. Cl. CPC A61H 1/005; H02K 33/18; A61H 23/0218

(57) ABSTRACT

A foldable massage apparatus including a plurality of vibrating devices in a flexible cover that is waterproof to provide for submerging the massage apparatus in a liquid, the massage apparatus being foldable to form a plurality of massage application surfaces that are contiguous with one another and that form an angled relationship with one another.

### CROSS REFERENCE TO RELATED APPLICATIONS

The present application claims the benefit of and priority to U.S. Provisional Patent Application No. 62/710,078, filed Feb. 9, 2018, the entire contents of which are incorporated by reference herein.

### FIELD OF THE INVENTION

The present disclosure relates to a portable vibrating massage mat adapted for safe use in a water environment to alleviate conditions such as stress, pain, soreness, stiffness, as well as to improve circulation and enhance overall well-being.

### BACKGROUND OF THE INVENTION

A wide variety of massage mats containing a vibrating apparatus is known in the art. Although some massage mats may be effective in relieving tension and further relaxing the body, they are limited in the scope of their operation. In particular, traditional vibrating massage mats are unsuitable and unsafe for use in a water environment. Soaking in warm water is one of the oldest forms of alternative therapy. Research has shown warm water therapy works wonders for all kinds of musculoskeletal conditions, including fibromyalgia, arthritis and lower back pain. It increases flexibility and allows the user to more fully relax, thereby promoting pain relief and encouraging better blood circulation. The inclusion of vibrational massaging in warm water therapy significantly increases these therapeutic benefits and relief to the user.

### SUMMARY OF THE INVENTION

A need, therefore, exists for a waterproof massage apparatus comprising vibratory elements and adapted to be impervious for use in a water environment.

Furthermore, a flexible waterproof massage apparatus according to the preferred embodiment of the present disclosure includes a plurality of eccentric rotating mass (ERM) vibratory motors individually sealed in corresponding impervious motor housings. The apparatus additionally includes light emitting diodes (LED) within a section of the massage apparatus that may be engaged to illuminate a surrounding environment. In addition, the apparatus includes a controller configured to selectively electrically couple the plurality of electric vibratory motors and LED lights to an electric power supply. The waterproof massage apparatus contains a pliant internal core to which the plurality of motor housings is coupled. The apparatus further includes an impervious cover that covers the entirety of components therein and described in the present disclosure to include the core, plurality of electric motors, lights and controller.

Some embodiments of the waterproof massage apparatus may further include a speaker and audio input. In such embodiments, the audio input is adapted to interface with an audio source via Bluetooth, Wi-Fi, or other wireless means. The controller is further configured to selectively electrically couple the speaker and audio input to the power source.

Additionally, in other embodiments, a heating element may be included. In such embodiments, the waterproof apparatus cover is further configured to cover the heating element and the controller is further configured to selectively electrically couple the heating element to the power source.

In addition, the waterproof massage apparatus in the preferred embodiment is provided with suction cups affixed thereabout to detachably connect the apparatus to the surface of a bathtub or other applicable vessel to securely hold the apparatus in position. In another embodiment, the apparatus is constructed in a manner and with materials that resist buoyancy and, thereby, rest on the floor of the bathtub without the aid of suction cups.

The apparatus in the preferred embodiment is foldable and completely portable, having a neutral state in which the apparatus is generally planar and a deformed state in which the apparatus is curved to fit a non-planar surface, such as the rear resting surface in a bathtub or similar positioning in other applicable apparatus or vessel. The apparatus is also suitable for use outside of the bathtub where its therapeutic benefits may be derived when positioned on compatible planar and nonplanar surfaces such as a bed, sofa, or floor.

The apparatus in the preferred embodiment may be powered by a rechargeable battery or batteries, having an externally accessible charging port such as inductive charging device, USB charging port, or similar connection.

In addition, the user interface operation in the preferred embodiment of the present invention may include wireless remote control of the features comprising the apparatus via infrared, Wi-Fi, Bluetooth, voice command technology, artificial intelligence technology, or any combination thereof. The waterproof massage apparatus may include external access to power the apparatus via a waterproof switch to couple and decouple the electrical power. Additional access utilizing a similar configuration may be provided for selectively providing power to individual electric components including vibratory motors, lights, audio and speaker, heating element, etc.

Furthermore, the user interface operation includes modes of operation that may be selectively programmed for targeted massage areas, massaging patterns, light color, sequences and patterns, audio playback, and heating element.

Additionally, the preferred embodiment of the waterproof massage apparatus may contain means to detect water temperature through digital temperature sensor technology and, through connection to the controller, present the results visually via a display panel and/or audibly (e.g. using voice command technology).

Furthermore, other embodiments of the present invention may contain means to detect the level of the water in relation to the position of the massage apparatus in the bathtub via a non-contact liquid level sensor and present the information visually via a display panel and/or audibly (e.g. using voice command technology).

Other and further objects of the present invention will be apparent from the following description and are illustrated in the accompanying drawings, which, by way of illustration, show the preferred embodiment of the present invention and the principles thereof and what are considered to be the best mode in which to apply these principles. Other embodiments of the invention embodying the same or equivalent principles may be used and structural changes may be made as desired by those skilled in the art without departing from the present invention.

### BRIEF DESCRIPTION OF THE DRAWINGS

FIG. 1 schematically illustrates the preferred embodiment of the waterproof massage apparatus according the present invention;

FIG. 2 is an isometric view of a vibratory motor;

FIG. 3 is a side view of the vibratory motor shown in FIG. 2;

FIG. 4 is a sectional top view of the vibratory motor in the motor housing according to the present invention;

FIG. 5 is a front view of the motor housing and vibratory motor partially exposed;

FIG. 6 is a front view of the motor housing;

FIG. 7a-7b is a partial sectional view along line B-B in FIG. 12 showing exemplary embodiments of a motor housing according to the present invention;

FIG. 8 is a sectional top view of the battery housing in the preferred embodiment of the present invention;

FIG. 9 is a sectional view along line A-A in FIG. 8 according to the present invention;

FIG. 10 is an isometric view of the control panel housing according to the present invention;

FIG. 11 is a side view of the partially open control panel housing;

FIG. 12 is a plan view of the waterproof massage apparatus in the preferred embodiment of the present invention;

FIG. 13 is a sectional view along line C-C of FIG. 12;

FIG. 14a-14b is an isometric view of a preferred embodiment of the waterproof massage apparatus having attached suction cups, and another embodiment without suction cups attached, respectively;

FIGS. 15a-15c illustrate a top view of the suction cup assembly according to the present invention;

FIGS. 16a-16c illustrate a partial side view along line D-D of FIG. 12 of the suction cup assembly according to the present invention;

FIG. 17 is a sectional top view of a low profile vibratory motor; and

FIG. 18 is a sectional side view of a low profile vibratory motor.

### DETAILED DESCRIPTION OF THE INVENTION

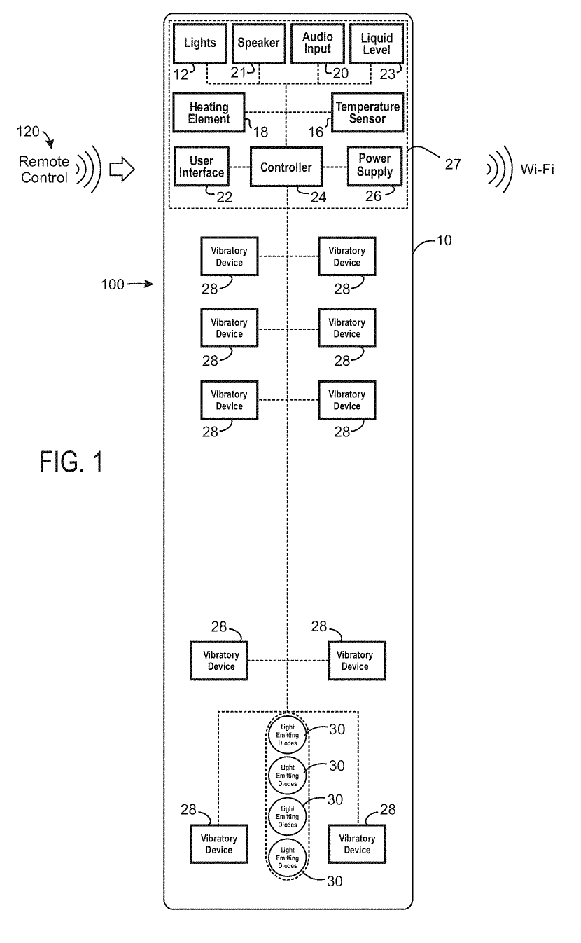

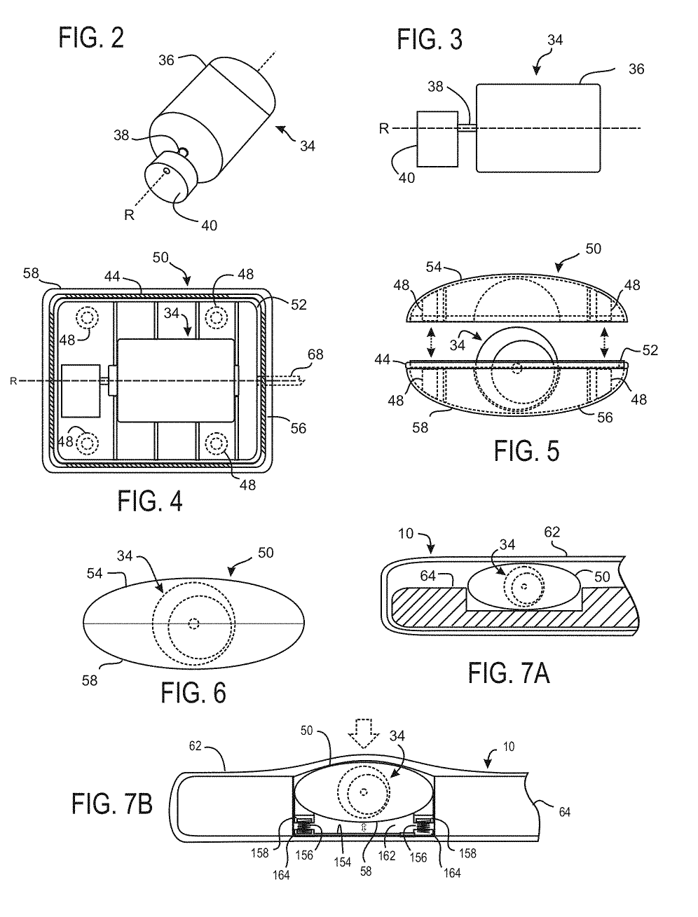

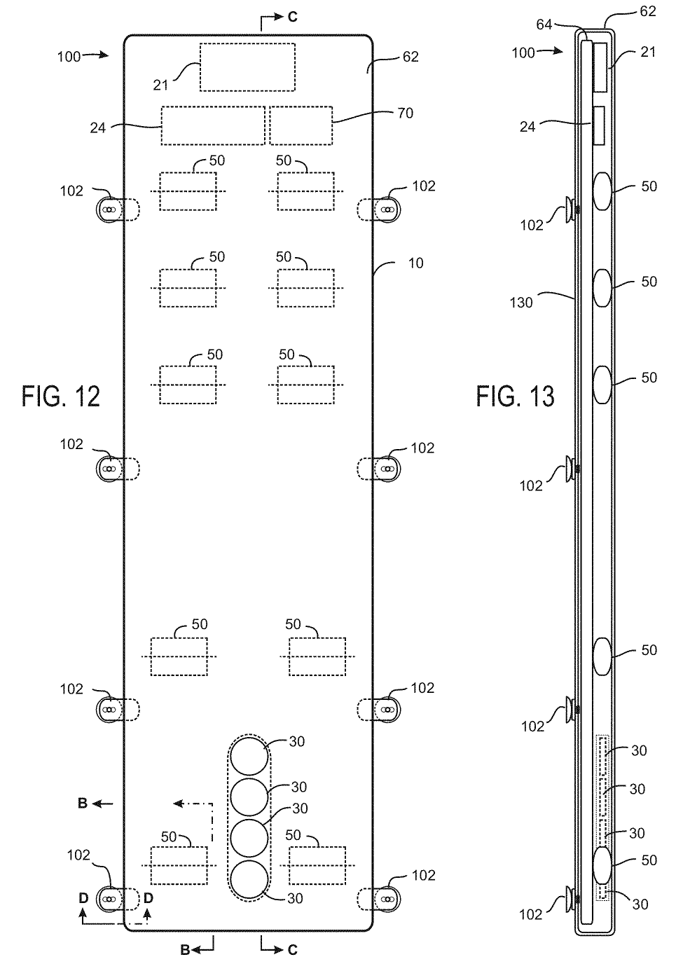

A waterproof massage apparatus 10, embodying the principles of the present invention, is shown in FIGS. 1-18 of the drawings to illustrate the preferred embodiment. Referring now to FIG. 12, the waterproof massage apparatus 10 comprises a cover 62 that is constructed of a durable waterproof material, such as polyester, nylon or others possessing similar properties, with thermoplastic coating and bonded together using advanced methods, such as high frequency welding. The apparatus includes a plurality of vibratory devices 28 electrically joined to and controlled by the controller 24. Each vibratory device is comprised of a vibration motor 34 and waterproof motor housing 50 and shall be further discussed in conjunction with FIGS. 2-6. The vibratory devices 28 may be electrically joined to each other in series, parallel, or any combination thereof, as appropriate.

The apparatus 10 further contains light emitting diodes (LEDs) 30 positioned about the center of the apparatus in a region of the lower section near the end of the apparatus to afford optimal illumination properties of the light source. The LED lights 30 are coupled to the massage apparatus 10 and electrically joined to the controller 24 which provides electrical power and controls the function of the LED lights 30, for example, their color, intensity, and preset modes of operation (e.g. flashing, fade, color patterns, etc.).

In addition, the massage apparatus 10 may include a speaker 21 electrically joined to the controller 24 and audio input 20 adapted to interface with an audio source via Bluetooth, Wi-Fi, or other appropriate technology. The controller 24 is configured to deliver audio received via the audio input 20 to the speaker 21.

A heating element 18 may be included in other embodiments of the present invention. In such an embodiment, the waterproof massage apparatus cover 62 is configured to cover the heating element 18. Furthermore, the heating element 18 is electrically coupled to and controlled by the controller 24. Additionally, the massage apparatus 10 may contain a non-contact liquid level sensor 23 to determine the surrounding water level in relation to the secured massage apparatus 10 in the medium. In addition, a temperature sensor 16 may be included to determine the temperature of the surrounding water environment. The liquid level sensor 23 and temperature sensor 16 in this embodiment are selectively electrically coupled with the controller 24. The results from the liquid level sensor 23 and the temperature sensor 16 may be presented visually via a display panel or audibly (e.g. announce temperature via voice command mode, etc.).

The user interface 22 may include control of the features embodied in the massage apparatus 10 via infrared, Wi-Fi, Bluetooth, voice command technology, artificial intelligence technology, or any combination, thereof. Through this configuration, the remote control 120 is in communication with the controller 24. In some embodiments, the user interface 22 may include a user-activated control such as a manual switch to selectively electrically couple the controller 24 to a power supply 26. In this embodiment, the user interface 22 is enclosed within the waterproof cover 62 of the massage apparatus. In another embodiment, the manual switch feature may be eliminated and the controller 24 is electrically coupled and decoupled to the power supply 26 via a signal from the wireless remote control 120.

Furthermore, the controller 24 is connected to the power supply 26. The power supply 26 in the preferred embodiment includes a rechargeable battery 60 such as a Lithium-Ion battery pack with an externally accessible charging port such as USB, or similar technology. Alternatively, in other embodiments, an inductive charging connectivity is provided to interface the rechargeable battery 60 to the charging device.

In operation, the user via the remote 120, selectively controls the power to the vibratory devices 28 and selects the area and duration of massage as well as the intensity of the vibratory stimulation such as low, medium or high. Furthermore, through the hand held remote 120, the user engages the LED(s) 30 to turn the lights on or off, select unique individual colors, and activate various programmed sequences of light display. Moreover, the LED 30 lighting device(s) may operate independently of the vibratory devices 28 and, thereby function as a stand-alone feature, or in correspondence with vibrations of one or more vibratory devices 28. The user may also activate power to the wireless speaker 21 via the remote 120 to connect wirelessly to sources using Bluetooth and Wi-Fi technology, such as smartphones and other similar devices, to stream music, environmental sounds, and other audio content.

In addition, the internal heating element 18 in another embodiment of the apparatus 10 is engaged through the remote control 120 to activate the element 18 and control the various temperature settings such as low, medium or high. In a similar fashion, the temperature sensor 16 and liquid level sensor 23 are both controlled via the hand held remote 120. When the temperature sensor 16 is activated, the temperature of the surrounding liquid (water) is displayed on a small LED screen residing on the remote 120. Similarly, when the liquid level sensor 23 is engaged by the remote control 120, the level of the water, in relation to the position of the apparatus in the bathtub, is transmitted to an LED screen on the remote control 120 unit and indicated as low, normal or high.

FIG. 2 and FIG. 3 illustrate an eccentric rotating mass (ERM) vibratory motor assembly 34 according to the present invention. The vibratory motor assembly 34 includes an ERM motor 36 with shaft 38 and eccentric mass 40. The ERM motor 36 is configured to generate rotation in the shaft 38 about a rotation axis R in response to an applied electrical current. The rotation further generates vibratory motion in the motor assembly 34. Referring to FIG. 4 and FIG. 5, the motor assembly 34 is securely enclosed in a waterproof motor housing 50.

FIG. 4 shows the top view of the eccentric rotating mass (ERM) vibratory motor assembly 34 in the base 58 of the motor housing 50. A rubber gasket 44 such as an O-ring is securely positioned about the neck formed by the extension at the top of the interior surface 52 above the wall of the base 58 of the motor housing 50. Referring to FIG. 5, the motor housing top 54 is attached to the motor housing base 58 by fasteners such as screw assemblies 48. Other embodiments may employ clamping or other similar methods to attach the top 54 of the motor housing securely to the base 58. Attaching the housing top 54 to the housing base 58 in this fashion comprises compressing the rubber gasket 44 to form an assembled waterproof enclosure for the vibratory motor assembly 34, as shown in FIG. 6.

FIG. 7A and FIG. 7B are illustrations along line B-B in FIG. 12, showing embodiments of the implementation of motor housing 50 containing a vibratory motor assembly 34. FIG. 7A shows, in one embodiment, the motor housing 50 attached to the pliant core 64 of the massage apparatus 10 and covered by the waterproof cover 62 of the massage apparatus 10. The core 64 layer may be composed of a flexible cushioning material including, rubber, nylon, PVC, or natural material with similar properties. FIG. 7B illustrates another embodiment for attachment of the motor housing 50 to the massage apparatus 10. The motor housing 50 is located in a pocket 162 created within the pliant core 64. A spring cup mount 158 is affixed to the motor housing base 58 and aligned parallel and opposite to a bottom spring cup mount 164 affixed to a stiffened horizontal member 154. A spring member 156 is mutually engaged and confined in a vertical and perpendicular position within and between the spring cup mounts 158, 164. In this arrangement, a force, such as the body weight of a user, exerted on the top 62 of the massage apparatus 10 and resulting in a downward pressure on the motor housing 50 engages the compression spring 156 and, thereby, inhibits dampening of the vibratory energy of the motor assembly.

Another embodiment of the massage apparatus uses a low profile vibrating motor 180 of the type shown in FIGS. 17-18, to generate vibratory motion for the apparatus. The low profile vibrating motor 180 uses a core coil 186 in the center and permanent magnets 182 and 184 positioned at both ends of the core 186 to create balanced push pull vibrating actions when electrical power is applied. The motor has a substantially reduced height to allow the massage apparatus to be thinner in size and provide more comfort during use.

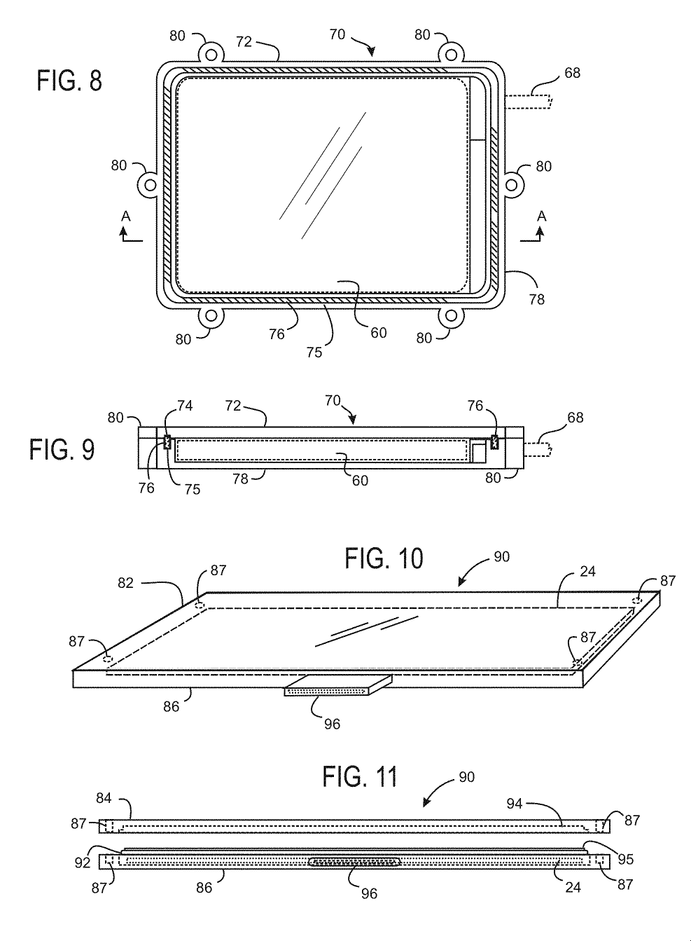

FIG. 8 illustrates a top sectional view of one embodiment of the battery housing assembly 70 and FIG. 9 is a sectional view along line A-A in FIG. 8. A rubber gasket 76 is securely positioned about the recess 75 in the battery housing base 78 adjacent to the location of the battery 60 where the top 72 connects to the base 78. The top 72 incorporates a corresponding depressed region 74 that aligns with the recess 75 in the base 78. The top 72 is attached to the base 78 at fastener location 80 by way of a screw assembly or similar arrangement. The rubber gasket 76 is compressed when the top 72 is properly secured to the base 78 to form a waterproof barrier that protects the battery 60 from exposure to water or moisture. Similarly, an impervious barrier is provided about the exit for the electrical cable 68 to ensure a completely impermeable enclosure for housing assembly 70.

FIG. 10 illustrates an isometric view of the control panel housing 90 and FIG. 11 illustrates a side view of the partially open control panel housing 90 of the present invention. A rigid enclosure 82 is provided to protect the controller 24 and shield it from any potential exposure to water or moisture. The enclosure 82 may be constructed of a lightweight impervious material, such as plastic or similar compound. The base 86 of the enclosure 82 is configured to engage with a corresponding top 84.

A rubber gasket 92 is securely positioned about the neck 95 formed by the raised portion of the interior surface of the housing base 86 adjacent to the location of the controller 24. The housing top 84 is configured with a corresponding recessed region 94. The housing top 84 aligns with and attaches to the base 86 by screw type fasteners 87. Other embodiments may employ clamping or other similar methods to attach the housing top 84 securely to the base 86 of the controller enclosure 82. Attaching the housing top 84 to the housing base 86 in this fashion comprises compressing the rubber gasket 92 to form a waterproof enclosure for the controller housing assembly 90. Similarly, an impervious barrier is provided about the exit for the electrical connector 96 to ensure a completely impermeable enclosure for the control panel housing 90.

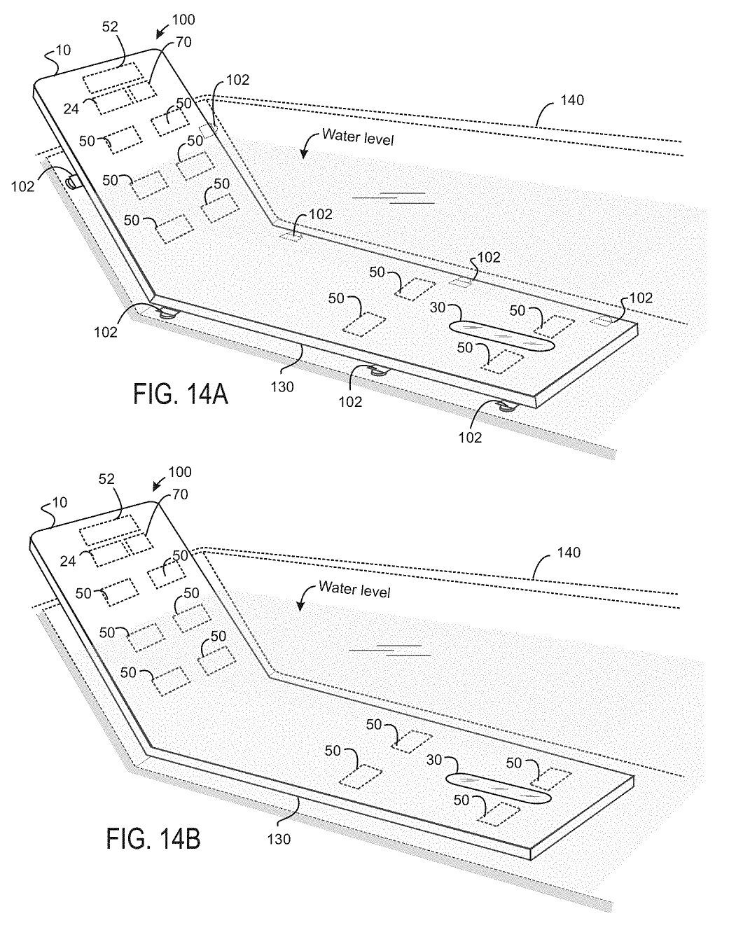

FIG. 12 and FIG. 13 illustrate a plan and sectional view, respectively, of the waterproof massage apparatus of the present invention to include the speaker 21, controller 24, and battery housing assembly 70, indicated by dotted lines. Likewise, the plurality of motor housings 50 and LED lights 30 are also displayed using dotted lines. In particular, FIG. 13 takes a section view along line C-C of FIG. 12. Both FIG. 12 and FIG. 13, show a plurality of suction cup assemblies 102 attached to the lower surface 130 of the massage apparatus 100 to provide a detachable connection to a bathtub or similar vessel. Additionally, FIG. 14A illustrates this arrangement in an isometric view of the waterproof massage apparatus 100 in a bathtub containing water. Similarly, FIG. 14B illustrates a view of the waterproof massage apparatus 100 in a bathtub without suction cups.

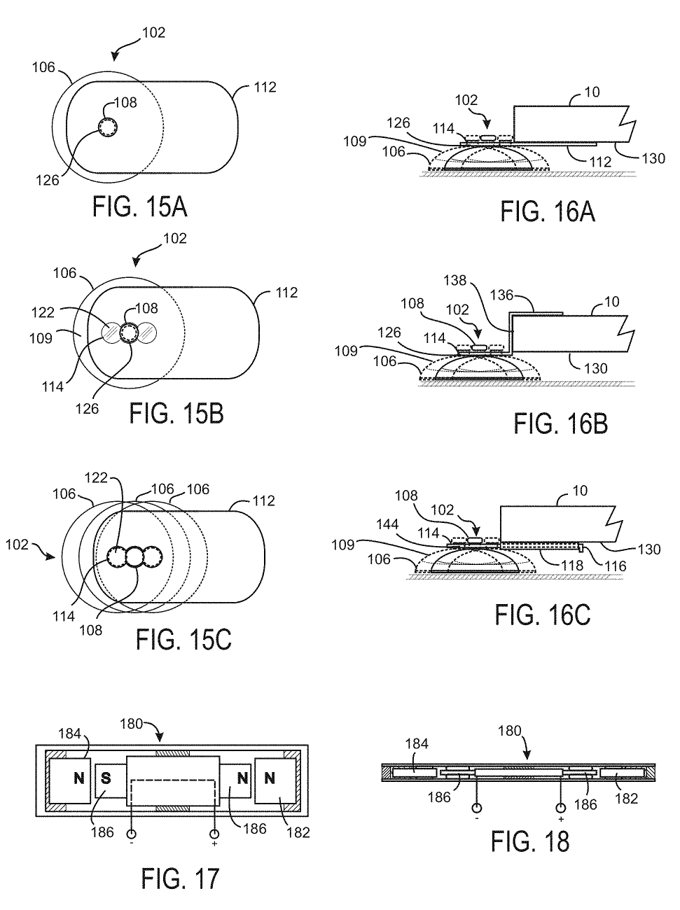

Furthermore, FIGS. 15A-16C show top views and side sectional views, respectively, that detail the suction cup assembly 102 as attached to the massage apparatus. In particular, FIG. 15A illustrates the suction cup 106 in one embodiment connected to a flexible elongated member 112 that is further attached to the lower surface 130 of the massage apparatus 10, as further detailed in FIG. 16A. In another embodiment, FIG. 15B shows the elongated member 112 containing a longitudinal track 114 consisting of undulating sections to form circular openings separated through intersecting edges, the centers of which may correspond to the diameter of the suction cup collar 126 located immediately beneath the top 108 and directly above the suction cup base 109. The track 114 opening slidably engages the suction cup 106 about the collar 126. The track 114, therefore, provides slidability, as shown in FIG. 15B-FIG. 16C, to afford movability of the suction cup 106 between positions closer to or farther away from the body 110 of the massage apparatus 100 to afford optimal positioning of the suction cup 106 to connect to the surface of the bathtub or similar vessel. Alternatively, FIG. 16B illustrates another embodiment with the suction cup assemble 102 attached to a flexible elongated member 136 attached about the side 138 and top of the massage apparatus 10. In still another embodiment, FIG. 16C illustrates a means by which the suction cup assembly 102 may be attachable and detachable from the massage apparatus 10. A hollow open-ended elongated sleeve element 118 is mounted horizontally along the bottom 130 of the massage apparatus 10. In this embodiment, the flexible elongated element 144 contains a downward turned end portion 116 which, when fully inserted through the hollow sleeve 118, the downward turned end portion 116 emerges from the open end portion of the sleeve 118 and, subsequently, forms a grip about the exterior of the end opening, thereby preventing the suction cup assemble 102 from dislodging without user intervention. Another embodiment of the present invention utilizes methods other than suction cups to secure the mat to the floor of the bathtub, including dense materials that do not float, and separate attachments to bathtub interior to connect to the massage apparatus.

Notwithstanding the forgoing, it is obvious that numerous changes may be made in the form and construction without departing from the spirit or scope of the invention, or sacrificing any of its attendant advantages, the form herein disclosed being a preferred embodiment for the purpose of illustrating the invention and not intended in a limiting sense.

1. A foldable massage apparatus, comprising:
one or more controller devices coupled to a power supply;
one or more pliant cores; and
a plurality of vibrating devices disposed in the one or more pliant cores and coupled to the one or more controller devices;
a flexible cover that covers at least the plurality of vibrating devices and the one or more lighting devices to form a plurality of massage application surfaces, the plurality of massage application surfaces being contiguous with one another,
wherein the flexible cover is foldable to form an angled relationship between the plurality of massage application surfaces, and
wherein the plurality of vibrating devices vibrate respective portions of the plurality of massage application surfaces as controlled by the one or more controller devices and powered by the power supply.

2. The foldable massage apparatus of claim 1, wherein the flexible cover is waterproof so that at least a portion of the plurality of massage application surfaces can be submerged in a liquid.

3. The foldable massage apparatus of claim 2, further comprising a liquid level detector that is coupled to the one or more controller devices and that detects a liquid level in proximity to the plurality of massage application surfaces.

4. The foldable massage apparatus of claim 2, further comprising a temperature sensor that is coupled to the one or more controller devices and that detects a liquid temperature in proximity to the plurality of massage application surfaces.

5. The foldable massage apparatus of claim 1, further comprising one or more lighting devices coupled to the one or more controller devices, wherein the one or more lighting devices are illuminated by the one or more controller devices in correspondence with one or more vibrations of the plurality of vibrating devices.

6. The foldable massage apparatus of claim 1, wherein the plurality of vibrating devices each comprise an eccentric rotating mass vibratory motor assembly.

7. The foldable massage apparatus of claim 1, further comprising one or more heating devices that are coupled to the one or more controller devices and that heat respective one or more portions of the plurality of massage application surfaces.

8. A foldable massage apparatus, comprising:
one or more controller devices coupled to a power supply;
a plurality of vibrating devices coupled to the one or more controller devices;
one or more heating devices coupled to the one or more controller devices; and
a flexible cover that covers at least the plurality of vibrating devices and the one or more heating devices to form a plurality of massage application surfaces, the plurality of massage application surfaces being contiguous with one another,
wherein the flexible cover is foldable to form an angled relationship between the plurality of massage application surfaces,
wherein the plurality of vibrating devices vibrate respective portions of the plurality of massage application surfaces as controlled by the one or more controller devices and powered by the power supply, and
wherein the one or more heating devices heat respective one or more portions of the plurality of massage application surfaces.

9. The foldable massage apparatus of claim 8, wherein the flexible cover is waterproof so that at least a portion of the plurality of massage application surfaces can be submerged in a liquid.

10. The foldable massage apparatus of claim 9, further comprising a liquid level detector that is coupled to the one or more controller devices and that detects a liquid level in proximity to the plurality of massage application surfaces.

11. The foldable massage apparatus of claim 9, further comprising a temperature sensor that is coupled to the one or more controller devices and that detects a liquid temperature in proximity to the plurality of massage application surfaces.

12. The foldable massage apparatus of claim 8, wherein the plurality of vibrating devices are disposed in one or more pliant cores.

13. The foldable massage apparatus of claim 8, wherein the plurality of vibrating devices each comprise an eccentric rotating mass vibratory motor assembly.
